(19) United States
(12) Patent Application Publication
(10) Pub. No.: US 2026/0175518 A1
(43) Pub. Date: Jun. 25, 2026

(54) 3D PRINTING WITH OUTCOME VERSION HISTORY

(71) Applicant: INTERNATIONAL BUSINESS MACHINES CORPORATION, Armonk, NY (US)

(72) Inventors: Jessica Nahulan, Vaughan (CA); Carolina Garcia Delgado, Zapopan (MX); Jeremy R. Fox, Georgetown, TX (US); Tiberiu Suto, Franklin, NY (US)

(21) Appl. No.: 18/999,111

(22) Filed: Dec. 23, 2024

(51) Int. Cl. B29C 64/386; B33Y 50/00

(52) U.S. Cl. CPC B29C 64/386; B33Y 50/00

(57) ABSTRACT

A computer-implemented method includes analyzing, by a processor, a database of past print attempts. Each past print attempt is associated with a print model version and print outcome data to compare with a new three-dimensional (3D) model to identify similar past print attempts in the database. An optimal print model version for the new 3D model is selected based on the print outcome data of the similar past print attempts. A 3D print job is initiated using the optimal print model version.

### BACKGROUND

The present invention generally relates to three-dimensional (3D) and four dimensional (4D) printing and, more particularly, to system and methods that associate print version and outcome information to improve print object quality.

While 3D printing provides a rapid methodology to realize prototype designs and other applications, many 3D printers still can experience high failure rates. A 3D print can fail based on a number of factors. For example, a different nozzle could be used, print settings may have changed, a different filament may have been used on a subsequent re-print, etc. In other scenarios, a model may be at fault as the model may not be very ‘printable’. For example, dimensions such as wall thickness, orientation, strength, model density, etc. can all play a role in determining the printability of the model.

To avoid these failures or bad designs, a 3D print can motivate a user to make tweaks to the 3D model for future prints. The process of printing and updating the model design can take multiple iterations. After iterations of re-printing a model, it can be difficult for a user to know which model file version in conjunction with which filament choice and print settings, etc. led to a best outcome for this particular model.

### SUMMARY

In accordance with an embodiment of the present invention, a computer-implemented method includes analyzing, by a processor, a database of past print attempts. Each past print attempt is associated with a print model version and print outcome data to compare with a new three-dimensional (3D) model to identify similar past print attempts in the database. An optimal print model version for the new 3D model is selected based on the print outcome data of the similar past print attempts. A 3D print job is initiated using the optimal print model version.

In accordance with another embodiment of the present invention, a computer system includes a processor set, one or more computer-readable storage media and program instructions stored on the one or more computer-readable storage media to cause the processor set to perform operations. The operations include analyzing a database of past print attempts, each past print attempt associated with a print model version and print outcome data to compare with a new three-dimensional (3D) model to identify similar past print attempts in the database, selecting an optimal print model version for the new 3D model based on the print outcome data of the similar past print attempts and initiating a 3D print job using the optimal print model version.

In accordance with another embodiment of the present invention, a computer program product includes one or more computer-readable storage media and program instructions stored on the one or more computer-readable storage media to perform operations. The operations include analyzing a database of past print attempts, each past print attempt associated with a print model version and print outcome data to compare with a new three-dimensional (3D) model to identify similar past print attempts in the database, selecting an optimal print model version for the new 3D model based on the print outcome data of the similar past print attempts; and initiating a 3D print job using the optimal print model version.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures, wherein:

FIG. 1 is a block diagram of a system for capturing and creating a 3D/4D model version history of 3D print results, in accordance with an embodiment of the present invention;

FIG. 2 is a flow diagram showing methods for capturing and creating a 3D/4D model version history of 3D print results, in accordance with an embodiment of the present invention;

FIG. 3 are graphical images showing stored print result profiles, in accordance with an embodiment of the present invention;

FIG. 4 is a block diagram showing a computer environment for capturing and creating a 3D/4D model version history of 3D print results, in accordance with an embodiment of the present invention; and

FIG. 5 is a flow diagram showing methods for selecting optimal model versions for 3D printing, in accordance with an embodiment of the present invention.

### DETAILED DESCRIPTION

In accordance with embodiments of the present invention, systems and methods are described for capturing and creating a 3D/4D model version history of 3D print results. Multiple cameras are employed with a 3D printer to capture multiple angles and viewpoints of the print result. Data is collected for printer settings, filaments used, environmental conditions, model file versions and other parameters and associated with the 3D print results. The print results are analyzed and recommendations for optimal print settings are made based on past print attempts.

Embodiments of the present invention address high failure rates in 3D printing by allowing users to visually inspect past print results, associated settings, and quality assessments. This enables easier identification of the best print settings and model versions for future prints.

In accordance with embodiments of the present invention, systems and methods are provided to capture a 3D/4D model version outcome history for 3D print results. A visual 3D model can be created representing the print result and be associated with information collected on print settings, filaments employed, print conditions at the time when the print was conducted and other useful data. Users would be able to visually see the history of 3D/4D print results, and view a compiled summary of identified flaws, and assessment of quality of the print result associated with that version of the print iteration. Embodiments can permit the user to easily identify which version of a print attempt led to a best or desired result, simplifying a recreation of the same or similar settings, conditions, etc. and identify which version of the model file to use and finalize for future prints.

By employing 3D printing systems in accordance with embodiments of the present invention to recommend print settings, model versions, print conditions, etc., which yielded the best results, time and material costs associated with 3D printing projects can be reduced. This is especially impactful for large-scale 3D printing projects, where even small improvements in efficiency can result in significant cost-savings. In addition, higher quality 3D printing with fewer defects and failures can be achieved. By leveraging the 3D printing system, an ability to fine-tune the print settings, conditions, and model version being used for a print being conducted can be achieved. Based on a user's own past custom print results unique to their system, print model, and environment, customized and personalized 3D printing solutions can be better achieved, which can be valuable in industries where customized and personalized products are in high demand, such as, e.g., in healthcare applications or consumer products.

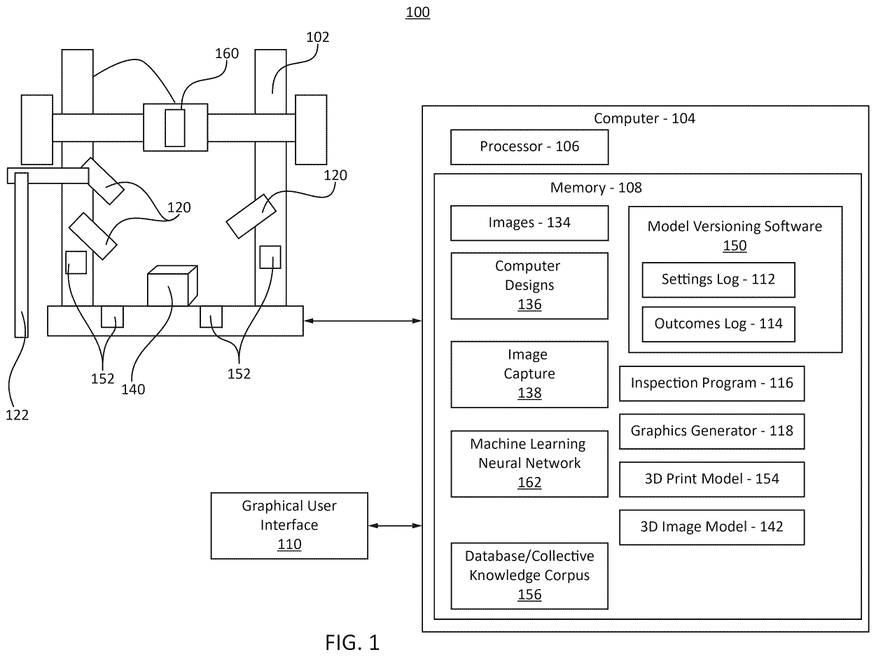

Referring now to the drawings in which like numerals represent the same or similar elements and initially to FIG. 1, a system 100 for associating outcomes with 3D/4D printer settings is shown and described in accordance with embodiments of the present invention. A printer 102 includes an additive manufacturing printer, such as, e.g., a 3D/4D printer. The printer 102 includes one or more cameras 120. The camera 120 can be placed at a number of locations and angles to gather data from a plurality of perspectives. The cameras 120 can be mounted on the printer 102 or can be included on a gantry 122 or other structure or structures that can permit adjustments to the positions of the cameras 120. The cameras 120 can be set for a particular print job and then readjusted in accordance with a next project or print job. The cameras 120 can include magnification capabilities, focus settings, aperture settings, etc. and lighting conditions, lighting angles, number of sources, etc., which can be set and adjusted, as needed. These camera settings and lighting settings can be part of a settings log 112 generated for each print job.

The system 100 includes one or more processing devices 104. The processing device 104 can include a computer, a cell phone or any other suitable processing devices that can run software and store data. The processing device 104 includes one or more processors 106 configured to control operations of the system 100 and to run software stored in a memory 108. The memory 108 can include any form of memory including but not limited to a hard drive with solid state memory.

The memory 108 stores program code that runs features in accordance with embodiments of the present invention. The memory 108 also stores data including the settings log 112, camera images 134, computer designs 136 (blueprints) for a model to be printed, etc.

The system 100 employs multiple cameras 120 to capture different angles of a 3D print object 140 (new 3D model) printed by the printer 102 once a print job is complete. Image capture software 138, stored in memory 108, is employed to record aspects of the print job during and after printing to permit a time lapse build-up of the printing process. The cameras 120 can focus on specific areas or regions of interest of the print object 140. For example, if there is an important feature that generates a large number of print failures, the process can focus on that feature. The image capture software 138 can be employed to compile captured footage into a 3D image model 142 that can be inspected and viewed by the user on a 3D model viewer on a graphical user interface (GUI) 110 of the system 100.

A model versioning program 150 is stored in memory 108 and works with the printing process to store settings and other data as designated by a user. The model versioning program 150 can provide a user with a menu or check box listing to enable the recordation of particular camera, printer or other parameters. This information can also have default settings for a particular print job or a particular print job type. The selected items from the menu will be stored in the settings log 112 for each print job. The settings can be changed, e.g., camera angles, etc. for each job but the data associated with these changes is stored in the settings log 112. The settings log 112 can include, e.g., printer settings, filaments loaded, environment conditions (e.g., temperature, humidity, etc.), nozzle selected, model version data (e.g., version numbers, design change data, etc.).

The 3D image model 142 created using the camera images 134 is associated with the settings log 112 so that the data is associated with the print job to be performed and to associate the data with a 3D print result stored in an outcome log 114 after the 3D object 140 has been printed.

When the print is completed, the system 100 can employ image footage from the cameras 120 to capture any defects or imperfections apparent in the final print outcome of the print object 140, such as unwanted cracks, holes, bumps, x-y-z alignment defects, breakpoints, etc. These defects will be used to compile a final quality summary in the outcomes log 114, which correlates the 3D print result of the print object 140 generated with print settings used (setting log 112), and this particular print attempt.

Quality of the print object 140 can be evaluated using an inspection program 116. The inspection program 116 can employ the captured images 134 from the cameras 120. In addition to visual inspection quality tests, other quality systems and metrics can also be employed. These can include, e.g., a photoelectric sensors quality test, ultrasonic sound quality test, structural defects quality test, etc.

Inspection sensors 152 or transducers can be included in the printer 102 or can be provided in a separate inspection station (along with visual inspection equipment) to evaluate quality of the print object 140. For example, after the print, a light test via photoelectric sensors can be performed. The light output when directed through the print object 140 can be employed as an indicator of object thickness to verify if expectations are met. The system 100 can identify how much light it expects at certain areas of the print object 140 based on shape, thickness, filament material, specifications, etc. In the case of the light diffuse sensors, the presence of an object in an optical field of view causes diffused reflection of the beam. A receiver can detect the light reflecting back from the print object 140. The reflected light can be employed as a measure of shape, surface textures, coloration, cosmetic faults (e.g., a blemish, a crack, an unsmoothed bump), etc.

The inspection sensors 152 or transducers can include ultrasonic transducers to permit a sound test that can transmit a short burst of ultrasonic waves toward the print object 140 or through the print objects 140, which reflects or transmits the ultrasound wave back to the inspection sensors 152 to indicate the print object density, structural integrity, shape, etc. Defects can be categorized as structural where the print object 140 has structural integrity compromised (e.g., weak or thin walls), Photoelectric sensors in combination with ultrasonic and image capture can be used for structural defect testing and data gathering. Image capture can be used to provide the details on identified cosmetic faults.

The results of the inspections and quality tests can be collected and stored in the outcome log 114 along with the data of the settings log 112 for each print object 140. A 3D print result model file 154 can be generated that includes an overall rating of the print job and information on defects and quality. The overall rating can be a combination of scoring methods that include weighting of particular criteria for that print job or print job type. For example, the print object 140 may be sensitive to a thickness at a particular point. The thickness at that point can be highly weighted as an indicator of quality. Other features and combinations of features can be employed to provide an indicator of outcomes.

When a user revisits the system 100 to conduct a print, the system 100 can analyze a model design input to the system 100 and identify which past print attempts correlate to the same model design by similarity of model design. The system 100 can then assess compiled 3D print result model files 154 of the final print results associated with each of the past print attempts. The system 100 can then analyze which printer settings, filament choice, environment conditions, and exactly which file version of the model design led to the best outcome, or which combination of factors from different print attempts may lead to the best outcome. The user can override these variables, such as, e.g., select a specific version of the model file to use or which filament should be employed. Using this data, the system 100 would be able to offer the user recommendations for print settings, file model version, print conditions, etc.

In an embodiment, a user can give the system 100 permission to automatically apply the recommendations to the system 100 for an upcoming print-job based on a best recommendation, which resulted in the best quality print result outcome. The system 100 can search for similar prints and between outcomes and provide recommended settings to optimize a print job. Alternatively, the user can also inspect the prior print result version history information by referring to 3D print result model files 154 or compilations of the 3D print result model files 154. This provides a print outcome collective knowledge corpus 156.

In an embodiment, a 3D viewing model can be created by a graphics generator 118. The graphics generator 118 can combine the camera images 134 collected in the 3D print result model files 154 and generate a 3D model of a final actual print result from a past print. A user can view the 3D viewing model and rotate the 3D viewing model, zoom in and inspect the 3D viewing model on the graphical user interface 110. The 3D viewing model shows resulting flaws and defects of the print object 140 and can be employed to visually assess and correlate print settings, print conditions and quality reports. The print result version history viewer permits the user to inspect for different combinations of parameters, e.g., available filament, current print settings, current print conditions, etc. and correlate these settings with acceptable outcomes or optimized outcomes.

In an embodiment, one or more cameras 160 can be placed on a print head facing a nozzle of the 3D printer. A video feed from the camera 160 can be analyzed in real-time for layer continuity and defect detection of a current or previous print layers. The camera 160 can gather data including, e.g., surface reflectivity, color differences, etc. that tend to occur in areas where the print may have a defect. Any defects that are detected can be tagged with coordinates of the print head at a point in time to easily enable locating the defect later. The defect can also be tagged with a severity designator, e.g., from 1 to 10, where 1 is a slight defect and 10 would be significant defect.

In addition, storing the defect coordinates can enable crowdsourcing this information and determination of specific points in the print cycle where certain models may exhibit high defect rates. The printer 102 may determine through machine learning (ML) algorithms using neural networks 162 or crowdsourced data analysis if the defects may be related to, e.g., a temperature (or other factors) that is too low or too high for that point of the print cycle and dynamically adjust the print head temperature higher or lower for a certain portion of the print cycle to ensure an error-free print.

The neural networks 162 include a system that improves its functioning and accuracy through exposure to additional empirical data. The neural network 162 becomes trained by exposure to the empirical data. During training, the neural network 162 stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network 162. Each example may be associated with a known result or output. Examples can include print outcomes associated with print settings, etc. Each example can be represented as a pair, (x, y), where x represents the input data and y represents the known output. The input data may include a variety of different data types, and may include multiple distinct values. The neural network 162 can have one input node for each value making up the example's input data, and a separate weight can be applied to each input value. The input data can, for example, be formatted as a vector, an array, or a string depending on the architecture of the neural network being constructed and trained.

The neural network 162 “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, a trained neural network 162 can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer of source nodes, and a single computation layer having one or more computation nodes that also act as output nodes, where there is a single computation node for each possible category into which the input example could be classified. An input layer can have a number of source nodes equal to the number of data values in the input data. The data values in the input data can be represented as a column vector. Each computation node in the computation layer generates a linear combination of weighted values from the input data fed into nodes of the input layer, and applies a non-linear activation function that is differentiable to the sum. The exemplary simple neural network can perform classification on linearly separable examples (e.g., patterns).

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers, because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . w_{n-1,} wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

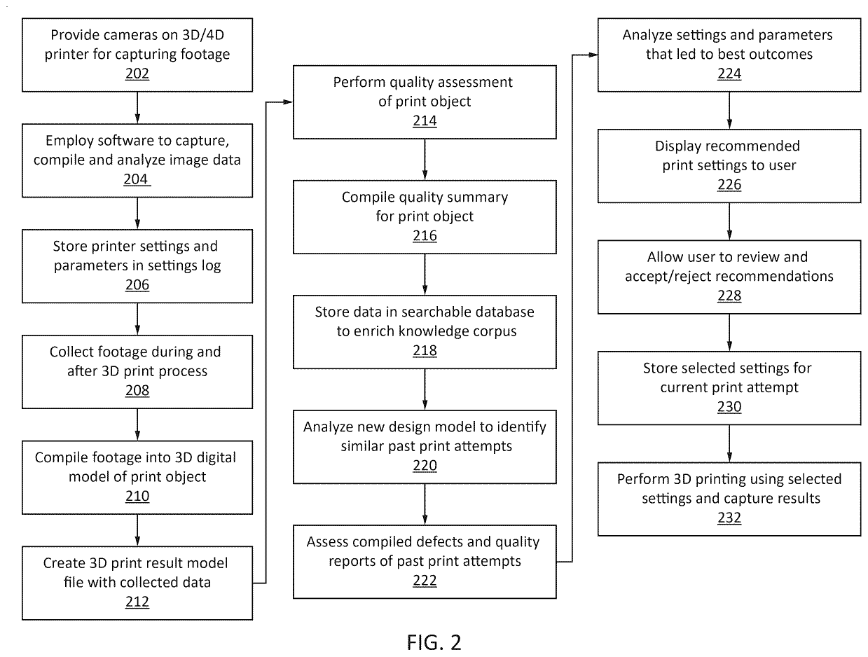

Referring to FIG. 2, a flow diagram depicts methods for capturing and creating a 3D/4D model version history of 3D print results in accordance with embodiments of the present invention. In block 202, cameras are provided on a 3D/4D printer for capturing footage. The cameras can be mounted on the 3D printer or other structure to capture footage from a number of angles of a 3D print object during printing, and once the print job is complete. The cameras can be adjusted before being securely fastened to capture images of areas of interest for video inputs.

In block 204, software for capturing, compiling, and analyzing data is employed to capture image footage from the cameras, compile the images into a 3D model to be inspected and viewed by the user on a 3D model viewer, and store and analyze data associated with the print object including printer settings, filaments used, room temperature, nozzle selected, model file version used for the print, etc.

In block 206, the 3D printer has print settings, such as, e.g., nozzle size, filament type, etc. stored in a settings log. The 3D printer can be configured with the settings as needed, such as the nozzle size and filament type which will be used for the print job. The system can be set up to collect the associated data such as printer or camera settings, filament choice, room temperature and humidity, nozzle selected, and model file version, etc. This data will be associated with the 3D print object in later steps. This data is collected and associated with the print to be conducted. This data should be collected to provide the user with an understanding of the exact settings and conditions that were used to produce the 3D print result object.

In block 208, footage is collected during and after the 3D print process by the cameras to capture footage of the 3D print object, e.g., when the print job is complete.

In block 210, the footage can be compiled into a 3D digital model of the print object. The digital model can be inspected and viewed by the user on a 3D model viewer on the system. The 3D model can represent an actual 3D print result object and can contain all (or most of the) necessary details.

In block 212, a 3D print result model file is created with the data collected. The 3D print result model file created is associated with the data collected such as the printer settings used, filament used, room temperature, nozzle selected, model file version used for the print, etc. This data is associated with the 3D print result model file to provide the user with an understanding of the exact settings and conditions that were employed to produce the print object.

In block 214, quality assessment is performed to collect data on the print object. The footage captured by the cameras and other inspection tools is employed to identify any defects or imperfections in the print object. The footage captured by the cameras can be used to locate features, such as, e.g., unwanted cracks, holes, bumps, x-y-z alignment defects, breakpoints, etc.

The quality assessment can include, e.g., photoelectric sensing, ultrasonic sensing, image capture and other testing/inspection processes to further assess structural defects and quality. This data can be employed to provide the user with an understanding of the exact structural defects and quality of the 3D print result object.

In block 216, a final quality summary is compiled for the print object. The final images and defects discovered can be employed to compile a final quality summary, which is correlated to the 3D print object generated along with print parameters such as, e.g., print settings used, and the (unique) print attempt on a specific 3D printer (which may be unique to this specific printer model, etc.).

In block 218, the final quality summary can be employed to enrich a knowledge corpus by storing the data collected in a searchable database. The data collected from the photoelectric sensors, ultrasonic sensors, image capture, settings, etc. can be input to data structures to permit a user with search capabilities in accordance with structural defects and quality of the 3D print object.

In block 220, the system can analyze a design model of an object to be printed and identify which past print attempts correlate to the design model by similarity of model designs. For example, if the user has printed the same model before, the system will identify the previous print attempts and provide the information for the new design model.

In block 222, the system can assess compiled defects and quality reports of the final print results associated with each of the past print attempts. This can include reviewing any defects or imperfections apparent in a final print outcome such as unwanted cracks, holes, bumps, x-y-z alignment defects, and breakpoints. The data can be employed to compile a final quality summary which will be correlated to the 3D print result model generated, print settings used, and the current print attempt.

In block 224, the system analyzes which printer settings, filament choices, environment conditions, etc. and which file version of the model design led to the best outcome. This can include a determination of which combination of factors from different print attempts might lead to the best outcome. For example, the system can determine that a combination of filament type A and room temperature of 72 degrees (Fahrenheit) led to the best result using desired criteria or specifications. The user can override these parameters or variables to fix conditions such as, e.g., fix a specific version of the model file that the uses wishes to use or which filament the user intends on using. The user can, e.g., override the filament type from type A to type B and the room temperature from a higher or lower room temperature. Using the collected data, the system will determine which printer settings, filament choice, environment conditions, and file version of the model design would lead to the best print outcome. This may be the same as the recommended settings or a combination of different settings from different print attempts.

In block 226, the system can then display the recommended print settings, which can include, e.g., filament choice, environment conditions, model file version to the user, etc. This can be done by displaying a summary of the recommended settings and a visual comparison of the print results associated with the recommended settings and any other settings that the user has selected or overridden.

In block 228, the user can then review the recommendations and decide to either accept and use them or reject them and set their own printer settings, filament choice, environment conditions, and model file version.

In block 230, once the user has decided, the system will store the selected printer settings, filament choice, environment conditions, and model file version to be used for the current print attempt. The system will also store the recommended printer settings, filament choice, environment conditions, and model file version in case the user wishes to reference this information again.

In block 232, the system performs the 3D printing process using the selected printer settings, filament choice, environment conditions, and model file version. The system will then create a 3D model representing the print result and associate it with the information collected on the print settings, filament, and print conditions used. The system will also capture any defects or imperfections apparent in the final print outcome and associate them with the 3D print result model generated.

In accordance with embodiments of the present invention, a 3D/4D printing process can avoid the drawbacks of many iterations of 3D printing, which include inspecting the outcome and re-tweaking the model file so that after many iterations, it becomes difficult to assess which version of the model that led to the best outcome. In many instances, it becomes difficult to reproduce a same print result as different filaments and printer settings are changed as part of print result testing. Embodiments of the present invention permit an easy look-up and browse through past print results for a model design. The present systems can recommend which print results yield the best outcomes for a given set of criteria. The system can compare the print result outcomes using a model result 3D viewer, which makes it easy to dispose of the failed printed object attempts using cataloged images of prior print attempts for a given set of printer settings/conditions.

A user can limit a number of print results to be considered by selecting criteria in a menu. If the user is only interested in the print results for a particular model design or type of model design, version numbers of interest or setting parameters of interest can be searched in the system. The system then reassess and provide the best recommended print result outcome associated with the input search criteria. The recommended print outcome result can be inspected in advance of printing by the user in the model result 3D viewer to determine cosmetic flaws, structural quality, etc. of the print result that the system recommends. If the recommended print result meets with the user's criteria, the system can configure a 3D printer with the filament to use, nozzle settings, etc. to re-create a 3D print result of similar quality using the recommended 3D model design file version.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

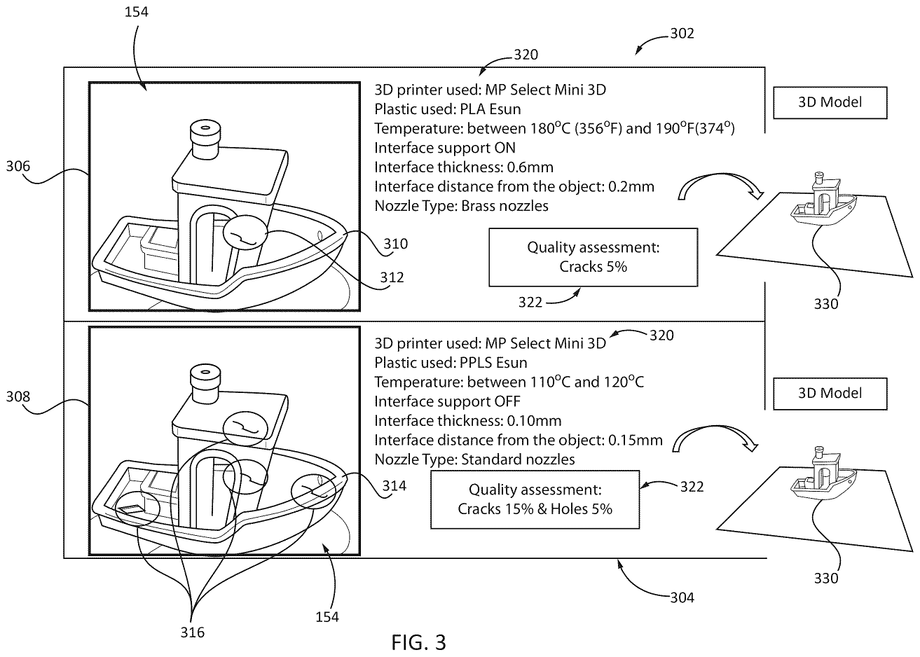

Referring to FIG. 3, graphical images of stored print result profiles 302 and 304 are described and shown in accordance with embodiments of the present invention. The 3D print result model file 154 can be generated that includes a quality assessment file 322 that provides an overall rating of the print job and information on defects and quality. The overall rating can be a combination of scoring methods that include weighting of particular criteria for that print job or print job type. For example, a print object may be sensitive to cracks or holes at particular locations. Other features and combinations of features can be employed to provide an indicator of outcomes.

The 3D print result model file 154 can include one or more print result profiles 302 and 304. Each of the print result profiles 302 and 304 can include one or more images 306 and 308 of printed print objects 310 and 314. The one or more images 306 and 308 can include still images or images, videos or a rendered 3D model 330 using the images 134 (FIG. 1) collected during the print job or after the print job during an inspection. The one or more images 306 and 308 can include defect callouts 312 and 316 where defects or regions on interest were encountered during the inspection. The defect callouts 312 and 316 can indicate a type and severity of the defects on the image itself or within the rendered model.

The one or more images 306 and 308 and other data including defects can be employed to generate the 3D model 330 of the print object for each job. This 3D model 330 can be used for observing the print quality. In an embodiment, the 3D model 330 can be overlayed on or otherwise viewed along with other 3D models 330 or digitally rendered versions of the print object (e.g., the digital model or an ideal or standard model).

The 3D print result model file 154 includes print data 320 for each print job. The print data 320 can include one or more of the following: an individual printer or type of printer used; filament and/or print materials used; temperature of the environment, whether support interfaces are employed, support interface thickness, support interface distance, nozzle types, other print parameters and criteria. The print data 320 is searchable and can be employed to refine a search based on outcome or other criteria. Searchable data can also include defect quantities, defect types, dimensional information, etc.

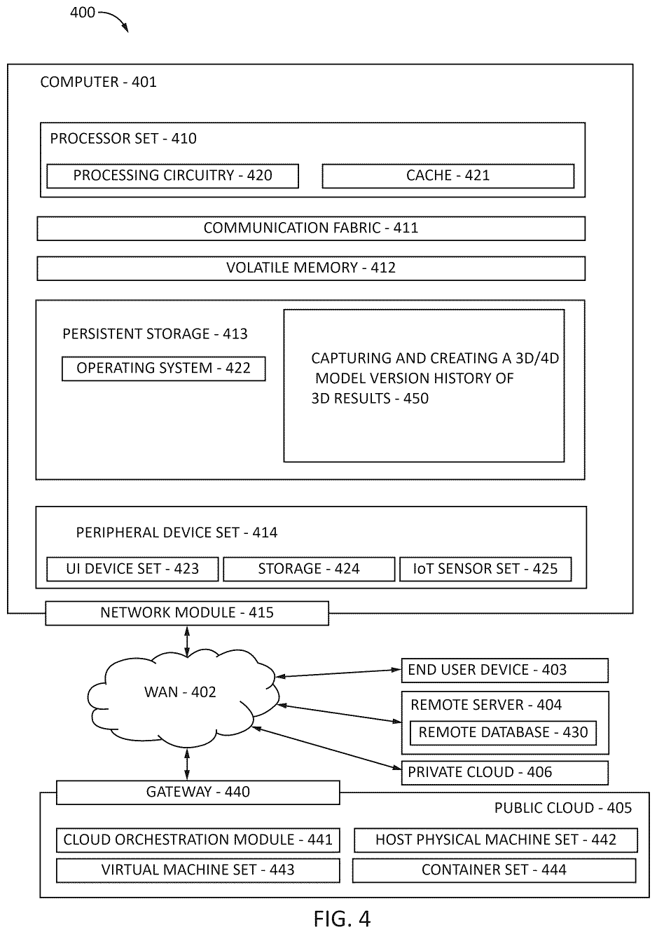

Referring to FIG. 4, a computing environment 400 contains an example of an environment for the execution of at least some of the computer code involved in performing the inventive methods, such as 3D printing with outcome version history 450. In addition to block 450, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 450, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 450 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 450 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

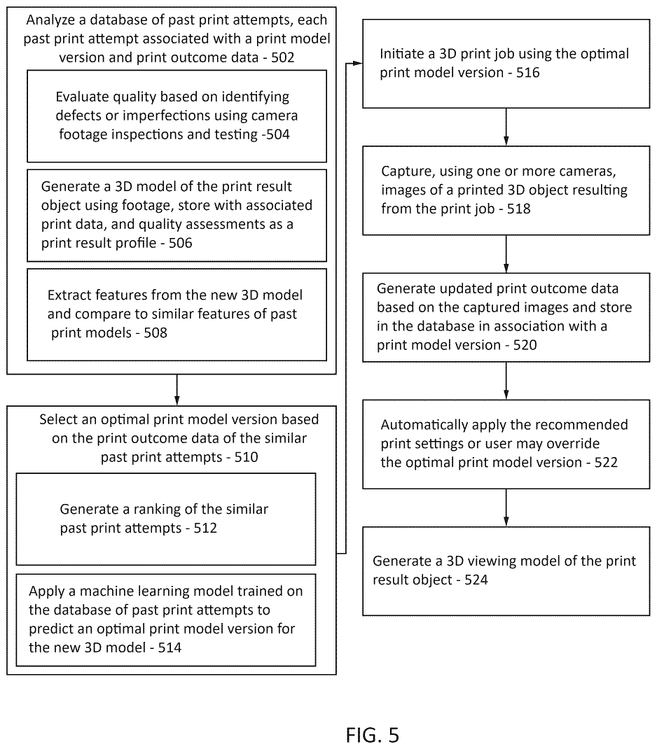

Referring to FIG. 5, a system/computer-implemented method for selecting optimal print settings in 3D printing in accordance with embodiments of the present invention is shown and described. In block 502, a processor analyzes a database of past print attempts, each past print attempt can be associated with a print model version and print outcome data. The print model version and print outcome data can be employed to compare against a new 3D model to be printed to identify similar past print attempts in the database. The print outcome data can include at least one of quality assessment scores, identified defects, filament type, nozzle type, print settings, model file version and environmental conditions.

In block 504, quality can be evaluated based on identifying defects or imperfections in the print result object using camera footage from the plurality of cameras. A quality summary associated with the print object can be based on the captured defects or imperfections can be compiled and stored. The quality assessment can include inspections and testing. Tests can include one or more of a photoelectric sensor test, an ultrasonic sound test, a structural defects test, etc.

In block 506, a 3D model can be generated of the print result object using footage from the plurality of cameras. The collected print data can be associated with the generated 3D model. The 3D model can be stored with associated print data, and quality assessments as a print result profile.

In block 508, features from the new 3D model can be extracted and compared to similar features of past print models. This can be employed to search the database for similar past print attempts. Print settings can be recommended based on the quality reports and past outcomes.

In block 510, an optimal print model version can be selected for the new 3D model based on the print outcome data of the similar past print attempts. In block 512, a ranking of the similar past print attempts can be generated based on their associated print outcome data. The ranking can be based on scoring criteria, combinations of features or these and other ranking criteria.

In block 514, a machine learning model trained on the database of past print attempts can be applied to predict an optimal print model version for the new 3D model based on input criteria.

In block 516, a 3D print job can be initiated using the optimal print model version.

In block 518, using one or more cameras, images of a printed 3D object resulting from the print job can be captured. In block 520, updated print outcome data can be generated based on the captured images and stored in the database in association with a print model version.

In block 522, the recommended print settings can automatically be applied for printing a new print object. A user can override the optimal print model version. The database can be updated to associate the user input (override) with the new print object.

In block 524, a 3D viewing model of the print result object can be generated, wherein the 3D viewing model is rotatable and zoomable for user inspection and comparison to the similar past print attempts.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method, comprising:
analyzing, by a processor, a database of past print attempts, each past print attempt associated with a print model version and print outcome data to compare with a new three-dimensional (3D) model to identify similar past print attempts in the database;
selecting, by the processor, an optimal print model version for the new 3D model based on the print outcome data of the similar past print attempts; and
initiating, by the processor, a 3D print job using the optimal print model version.

2. The method of claim 1, wherein the print outcome data includes at least one of:
quality assessment scores, identified defects, print settings and environmental conditions.

3. The method of claim 1, wherein analyzing the new 3D model includes:
extracting features from the new 3D model; and
comparing the features to similar features of past print models.

4. The method of claim 1, further comprising:
generating a ranking of the similar past print attempts based on their associated print outcome data.

5. The method of claim 1, further comprising:
receiving user input to override the optimal print model version; and
updating the database to associate the user input with the new 3D model.

6. The method of claim 1, further comprising:
capturing, using one or more cameras, images of a printed 3D object resulting from the 3D print job;
generating updated print outcome data based on the captured images; and
storing the updated print outcome data in the database in association with a print model version.

7. The method of claim 1, wherein selecting the optimal print model version includes:
applying a machine learning model trained on the database of past print attempts to predict an optimal print model version for the new 3D model.

8. A computer system, comprising:
a processor set;
one or more computer-readable storage media; and
program instructions stored on the one or more computer-readable storage media to cause the processor set to perform operations comprising:
analyzing a database of past print attempts, each past print attempt associated with a print model version and print outcome data to compare with a new three-dimensional (3D) model to identify similar past print attempts in the database;
selecting an optimal print model version for the new 3D model based on the print outcome data of the similar past print attempts; and
initiating a 3D print job using the optimal print model version.

9. The computer system of claim 8, wherein the print outcome data includes at least one of: quality assessment scores, identified defects, print settings and environmental conditions.

10. The computer system of claim 8, wherein analyzing the new 3D model includes:
extracting features from the new 3D model; and
comparing the features to similar features of past print models.

11. The computer system of claim 8, wherein the operations further comprise:
generating a ranking of the similar past print attempts based on their associated print outcome data.

12. The computer system of claim 8, wherein the operations further comprise:
receiving user input to override the optimal print model version; and
updating the database to associate the user input with the new 3D model.

13. The computer system of claim 8, wherein the operations further comprise:
capturing, using one or more cameras, images of a printed 3D object resulting from the 3D print job;
generating updated print outcome data based on the captured images; and
storing the updated print outcome data in the database in association with a print model version.

14. The computer system of claim 8, wherein selecting the optimal print model version includes:
applying a machine learning model trained on the database of past print attempts to predict an optimal print model version for the new 3D model.

15. A computer program product comprising:
one or more computer-readable storage media; and
program instructions stored on the one or more computer-readable storage media to perform operations comprising:
analyzing a database of past print attempts, each past print attempt associated with a print model version and print outcome data to compare with a new three-dimensional (3D) model to identify similar past print attempts in the database;
selecting an optimal print model version for the new 3D model based on the print outcome data of the similar past print attempts; and
initiating a 3D print job using the optimal print model version.

16. The computer program product of claim 15, wherein the print outcome data includes at least one of: quality assessment scores, identified defects, print settings and environmental conditions.

17. The computer program product of claim 15, wherein analyzing the new 3D model includes:
extracting features from the new 3D model; and
comparing the features to similar features of past print models.

18. The computer program product of claim 15, wherein the operations further comprise:
generating a ranking of the similar past print attempts based on their associated print outcome data.

19. The computer program product of claim 15, wherein the operations further comprise:
receiving user input to override the optimal print model version; and
updating the database to associate the user input with the new 3D model.

20. The computer program product of claim 15, wherein selecting the optimal print model version includes:
applying a machine learning model trained on the database of past print attempts to predict an optimal print model version for the new 3D model.
